(19) United States
(12) Patent Application Publication
(10) Pub. No.: US 2003/0050121 A1
(43) Pub. Date: Mar. 13, 2003

(54) Torque limiter and rotary member with the torque limiter

(76) Inventors: Seiichi Takada, Mie (JP); Masaaki Honda, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/235,913

(22) Filed: Sep. 6, 2002

(30) Foreign Application Priority Data
Sep. 7, 2001 (JP) 2001-272169
Mar. 27, 2002 (JP) 2002-88651

(51) Int. Cl. F16D 7/02

(52) U.S. Cl. 464/40

(57) ABSTRACT

It is aimed to provide a compact torque limiter to be used for a personal printer. It has a sleeve having an annular boss portion, and a ring-like elastic member. The sleeve generates a radial force relative to a shaft inserted in the sleeve by imparting elasticity in the diameter-reducing direction to the sleeve by fitting an elastic member onto the sleeve to reduce its diameter.

### BACKGROUND OF THE INVENTION

This invention relates to a torque limiter and a rotary member with a torque limiter which are used in a driving unit such as a paper feed portion of a small printer such as a personal printer.

As torque limiters used in driving units of office machines such as paper feed portions, friction type and magnetic type ones are known heretofore. Ones known as friction type torque limiters comprise, as disclosed in JP patent publication 11-247881, an inner member, an outer member relatively rotatably fitted on the inner member, a coil spring fitted on the outer surface of the inner member with a required binding force, and a lid fitted on the outer member between the inner member and the outer member. A hook at one end of the coil spring is in engagement with the outer member and a hook at the other end is in engagement with the lid to produce a predetermined torque by friction between the inner member and the coil spring.

Such a torque limiter is coupled to a rotary member such as a roller on a shaft and is positioned relative to the shaft by fixing one end with a pin and the other end with a snap ring.

While more compact office machines are required, since such conventional torque limiters are formed by a combination of parts such as the outer member and the inner member, there is a certain limit in reducing the outer diameter of the torque limiters. In order to reduce the number of parts, it is conceivable to make a rotary member such as a roller integral with the outer member of the torque limiter. But the manufacturing steps become complicated and thus the productivity lowers.

If torque adjustment is made after assembling a torque limiter, it is made while carrying out torque measurement with the inner member rotating and the outer member supported by a fixing jig. But with a structure integral with a rotary member as described above, torque adjustment has to be made with the rotary member supported with the fixing jig. But since the rotary member is of different shapes according to its use, the fixing jig has to be prepared according to its use and setup has to be changed accordingly.

An object of this invention is to provide a torque limiter in which compactness has been achieved by reducing the number of parts and which needs no torque adjustment, and a rotary member with the torque limiter.

### SUMMARY OF THE INVENTION

Means 1

According to this invention, there is provided a torque limiter comprising a sleeve having an annular boss portion and mounted on a shaft, and a ring-like elastic member, the sleeve being imparted elasticity in the diameter-reducing direction, the elastic member being mounted on the sleeve to shrink the sleeve, whereby generating a radial force relative to the shaft.

With this arrangement, a predetermined torque is produced due to the radial force by the sleeve and the frictional force between the sleeve and the shaft. By setting the part dimensions of the elastic member to predetermined values, it is possible to obtain a predetermined torque without making torque adjustment after assembling. By using a self-lubricating resin as the material for the sleeve, a case member for preventing scattering and leak of lubricants is not needed any more.

As the self-lubricating resin, a polyacetal resin (POM), oil-containing plastics, polyamide resin, polyimide resin, high-density polyethylene resin, polybutylene terephthalate resin (PBT), ABS resin, fluorine resin (PTFE), polymer alloy containing fluorine resin, polyphenylene sulfide resin (PPS), polycarbonate resin (PC), liquid crystal polymer resin (LCP), polyphenylene oxide resin (PPO) may be used.

As the elastic member, it is possible to use a tubular spring formed with an axial slit, a plurality of such tubular springs superposed one upon another, a coil spring, an elastic C-shaped ring, or the like.

Means 2

According to this invention, there is provided a rotary member with a torque limiter, comprising a rotary member and a torque limiter provided at one end of the rotary member, the torque limiter comprising a split sleeve formed with a plurality of axial slits and a spring mounted on the split sleeve to generate a torque between the split sleeve and the shaft, wherein the split sleeve is formed to spread at one end thereof and has its diameter reduced to a required diameter by the binding force of the spring.

With this arrangement, since the slits are formed wider than conventional, it is possible to ensure sufficiently thick slit forming portions on a mold. As a result, the mold is less likely to chip.

Also, according to this invention, the split sleeve has a plurality of sleeve pieces and the width of the tips of the sleeve pieces is set such that they abut each other to form an annular portion when the split sleeve is shrinked by the binding force of the spring, and wherein the width of portion of the sleeve pieces other than the tips thereof is smaller than the width of the tips. With this arrangement, when the split sleeve is shrinked by the binding force of the spring, the diameter of the opening at its tip is limited to the diameter of the annular portion formed by the sleeve pieces. Thus, the relation between the inner diameter of the annular portion and the outer diameter of the shaft can be designed such that a predetermined torque can be obtained and the insertion is easy.

According to this invention, radial bearings are formed on the inner surface of the rotary member at both ends thereof, the radial bearings each comprising a plurality of bearing ribs arranged in a circumferential direction, the phases of the positions of the bearing ribs are displaced from each other. With this arrangement, even though the bearing ribs are provided on the inner surface of the rotary member at both ends, axial release of the mold is possible and thus molding is possible.

It is possible to employ an arrangement wherein the spring is a coil spring, wherein the fraction of the number of windings of the spring is set to less than a half turn, and wherein hooks are provided at both ends thereof and bent diametrically outwardly. In such a winding arrangement, since a major arc and a minor arc are present between the hooks at both ends, when the hooks are pulled toward each other toward the minor arc side, the coil spring will expand. This makes insertion of the shaft easy. In this case, the fraction of the number of windings, i.e. the angle of the minor arc is preferably 20 to 45 degrees. Also, a rotary member with a torque limiter is provided wherein engaging portions for engagement with the hooks are formed on the end face of the rotary member on the side facing the torque limiter and circumferential flexibility is imparted to one of the engaging portions. By deflecting the flexible engaging portion toward the minor arc side, it is possible to easily increase the diameter of the coil spring.

As the spring, C-shaped springs having springness may be used. By changing their number, it is possible to adjust the binding force.

Means 3

According to this invention, there is provided a rotary member with a torque limiter, comprising a rotary member and a torque limiter provided at one end of the rotary member, the torque limiter comprising a split sleeve formed with a plurality of axial slits and a spring mounted on the split sleeve to generate a torque between the split sleeve and the shaft, wherein the split sleeve is split into at least two sleeve pieces, and the ratio of the circumferential length of the each sleeve piece to its axial length is 0.9±0.1.

Also, an arrangement in which the spring is mounted on the split sleeve at a position adjacent to the rotary member, an arrangement in which an annular recess is formed in the split sleeve at a position where the spring is mounted, or an arrangement in which the axial length of the split sleeve is equal to or larger than the diameter of the shaft.

### BRIEF DESCRIPTION OF THE DRAWINGS

Other features and objects of the present invention will become apparent from the following description made with reference to the accompanying drawings, in which:

FIG. 1 is an exploded perspective view of a first embodiment;

FIG. 2 is a sectional view of the same;

FIG. 3 is a sectional view along line III-III of FIG. 2;

FIGS. 4A and 4B are perspective views of modified examples of the elastic member of the same;

FIG. 5 is a sectional view of the second embodiment;

FIG. 6 is a perspective view showing a portion of the same;

FIG. 7 is a sectional view of a third embodiment;

FIG. 8 is a perspective view showing a portion of the same;

FIG. 9 is a sectional view of a fourth embodiment;

FIG. 10 is a perspective view showing a portion of the same;

FIG. 11 is a sectional view for explaining problems;

FIG. 12 is a sectional view of a fifth embodiment;

FIG. 13A is a perspective view of the same;

FIG. 13B is a front view of the coil spring of the same;

FIG. 14 is an exploded perspective view showing a portion of the same in section;

FIG. 15 is a sectional view showing a portion of a modified example of the same;

FIG. 16 is an exploded perspective view showing a portion of the same;

FIG. 17 is a sectional view of a sixth embodiment;

FIG. 18 is an exploded perspective view of the same;

FIG. 19 is a sectional view of a seventh embodiment;

FIG. 20 is an exploded perspective view of the same;

FIGS. 21A and 21B are sectional views for comparison of the split sleeves;

FIG. 22A is a partial side view of the arrangement used for an experiment;

FIG. 22B is a front view of the same;

FIG. 22C is a graph showing the experiment results;

FIG. 23A is a partial side view of another arrangement used for an experiment;

FIG. 23B is a front view of the same;

FIG. 23C is a graph showing the experiment results;

FIG. 24A is a partial side view of a still another arrangement used for an experiment;

FIG. 24B is a front view of the same;

FIG. 24C is a graph showing the experiment results;

FIG. 25A is a partial side view of a further arrangement used for an experiment;

FIG. 25B is a front view of the same; and

FIG. 25C is a graph showing the experiment results.

### DETAILED DESCRIPTION OF THE PREFERRED EMBODIMENT

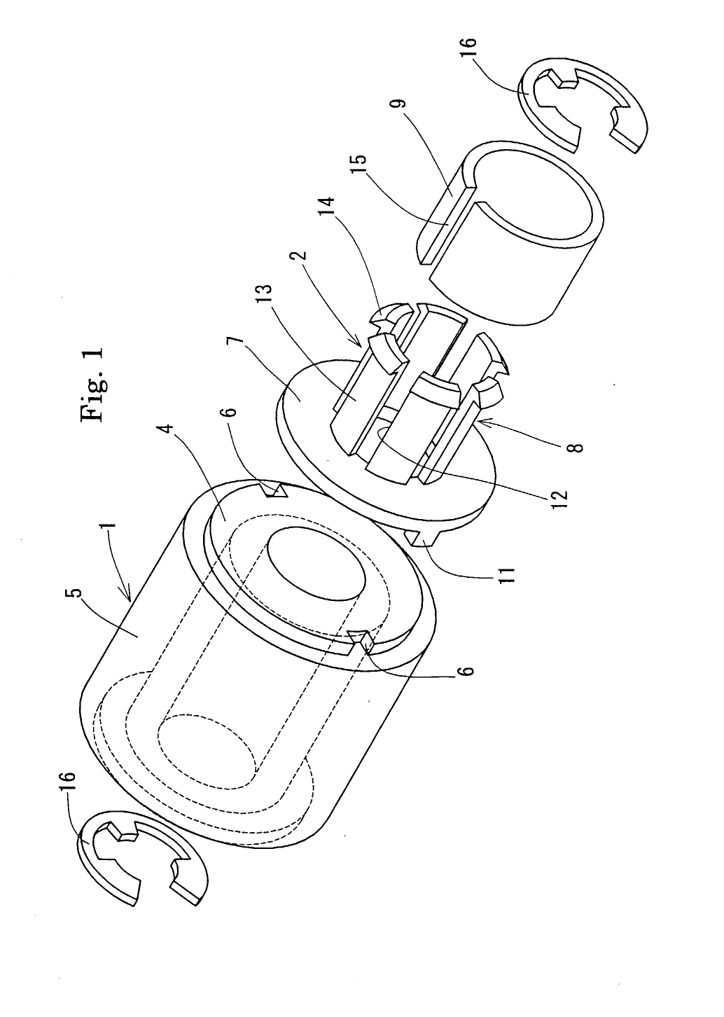

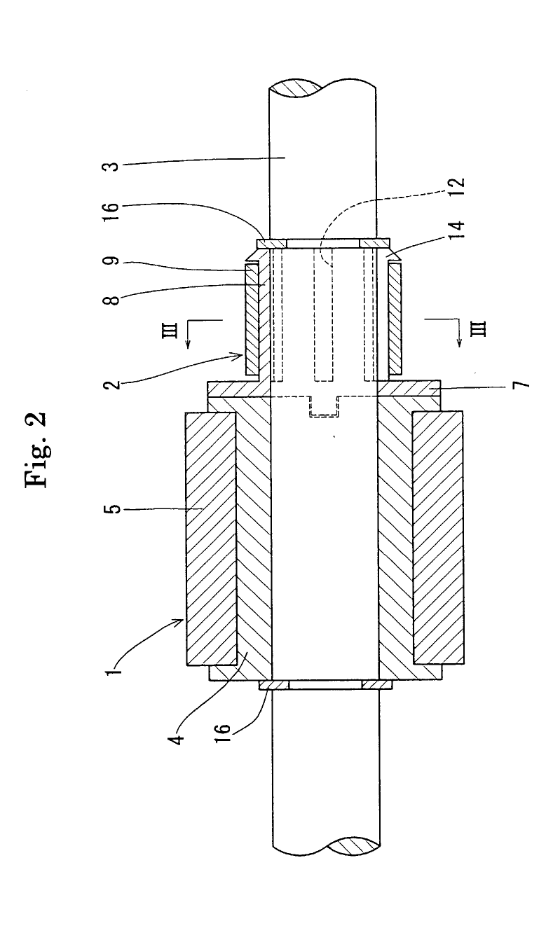

Hereinbelow, the embodiments of this invention will be described with reference to the attached drawings. The roller with a torque limiter of the first embodiment shown in FIGS. 1 and 2 comprises a roller portion 1 and a torque limiter portion 2 and is fitted on the outer periphery of a shaft 3 in use.

The roller portion 1 has a roller body 4 on which is mounted a rubber roller 5. Recesses 6 for engagement with the torque limiter portion 2 are formed in one end face of the roller body 4. The roller portion 1 is rotatably mounted on the shaft 3.

The torque limiter portion 2 comprises an annular boss portion 7 adapted to abut one end face of the roller body 4, a sleeve 8 coaxially formed on one side thereof, and a ring-shaped elastic member 9 fitted on the sleeve 8. The boss portion 7 is provided with a pair of engaging protrusions 11 on the side opposite to the sleeve 8, which engage in the recesses 6 so as to couple the boss portion 7 to the roller body 4 in the rotational direction and concentrically relative to the shaft 3.

The sleeve 8 is formed with slits 12 that are open at their tips at regular spacings in the circumferential direction. In other words, it is split into a plurality of sleeve pieces 13. At the tip of each sleeve piece 13, an outwardly rising protrusion 14 is provided. The sleeve 8, which comprises the boss portion 7 and the split sleeve pieces 13, is an integrally formed member of synthetic resin. The sleeve 8 has shrinkage elasticity in a radial direction. The elastic member 9 is fitted on the outer peripheral surface of the sleeve 8 and is prevented from coming out by the protrusions 14.

The elastic member 9 is made of a synthetic resin or a metal and is formed into a tubular spring formed with an axial slit 15. Its inner diameter is formed slightly smaller than the outer diameter of the sleeve 8 to impart a radial force to the sleeve 8.

The thus assembled roller portion 1 and the torque limiter portion 2 are fitted onto the shaft 3 and axially positioned by E-shaped snap rings 16 at both ends thereof.

The roller with the torque limiter of the first embodiment having such a structure is used in a small printer such as a personal printer. If the load acting on the roller portion 1 is below a predetermined level, the roller portion 1 and the torque limiter portion 2 will rotate integrally under a torque applied to the shaft 3 at the torque limiter portion 2. If the load exceeds a predetermined torque, the torque limiter portion 2 will idle relative to the shaft 3, so that the roller portion 1, which is coupled thereto, also idles relative to the shaft 3. Thus, transmission of torque is not done.

In this torque limiter, by setting the dimensions of the elastic member 9 constant, the radial force of the sleeve 8 becomes constant, so that the torque value also becomes constant. Thus it is not necessary to make torque adjustment after assembly.

Also, by using a material having self-lubricity as the synthetic resin for the sleeve 8, no lubricant is necessary. Thus no case member for preventing scattering, leak or the like of the lubricant is necessary.

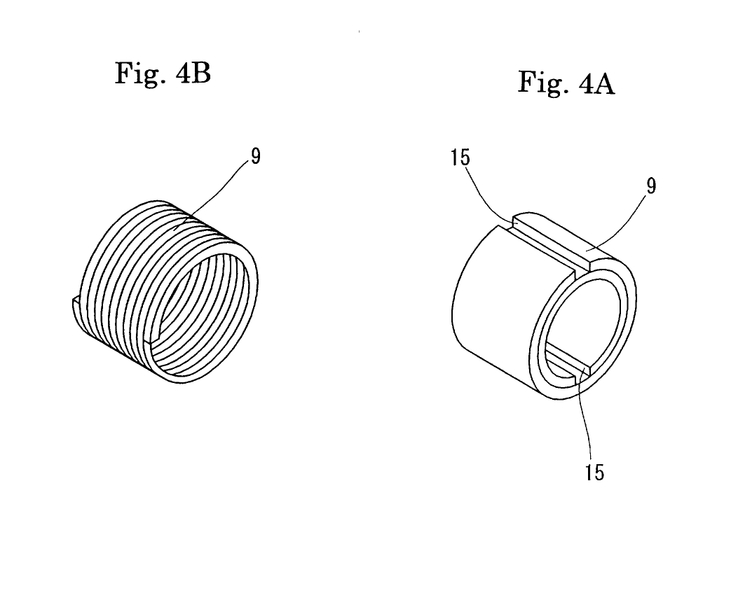

As the elastic member 9, a single tubular spring cut apart at one circumferential location by the axial slit 15 is shown. But one in which similar tubular springs are superposed in multiple layers as shown in FIG. 4A or one in the form of a coil spring as shown in FIG. 4B may be used. These make it possible to produce a higher torque. The modified examples of the elastic member 9 may be used in the following embodiments, too.

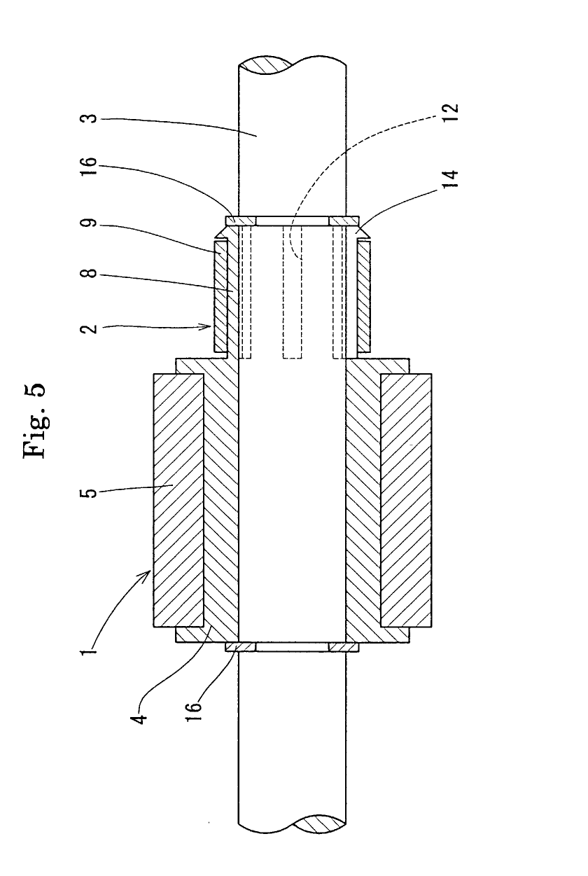

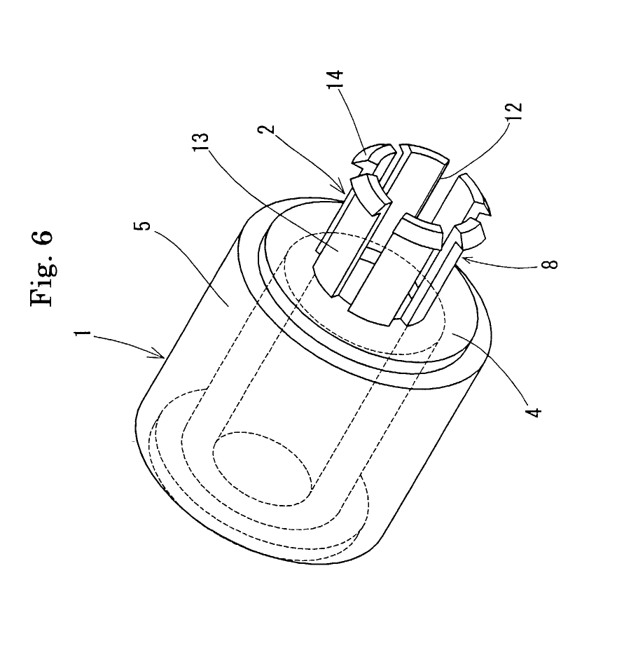

Next, in the rotary member with a torque limiter of the second embodiment shown in FIGS. 5 and 6, the roller portion 1 and the torque limiter portion 2 are integral with each other. That is, the sleeve 8 is integrally and concentrically formed at one end of the roller body 4. In other words, the boss portion 7 of the torque limiter portion 2 in the first embodiment is integral with an end face of the roller body 4. Other structures and functions are the same as with the first embodiment.

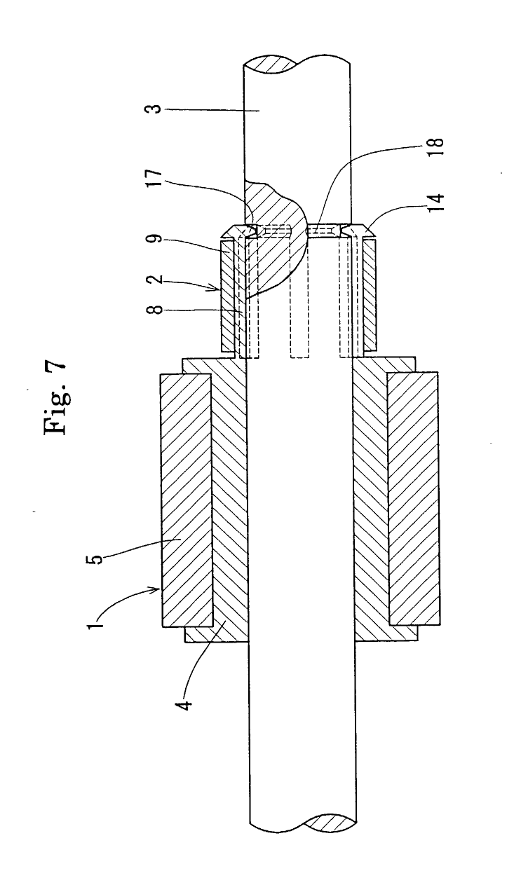

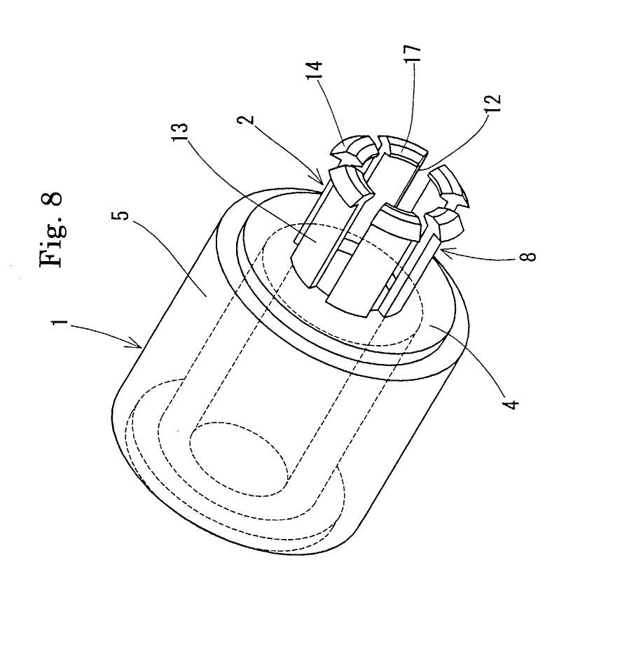

The rotary member with a torque limiter of the third embodiment shown in FIGS. 7 and 8 is the same as the second embodiment in that the roller portion 1 and the torque limiter portion 2 are integral with each other. It differs in that the positioning snap rings 16 are omitted and that a positioning claw 17 is formed on the inner periphery of each sleeve piece 13 forming the sleeve 8 at its tip. By engaging the positioning claws 17 in an annular groove 18 in the shaft 3, the sleeve 8 is positioned relative to the shaft 3.

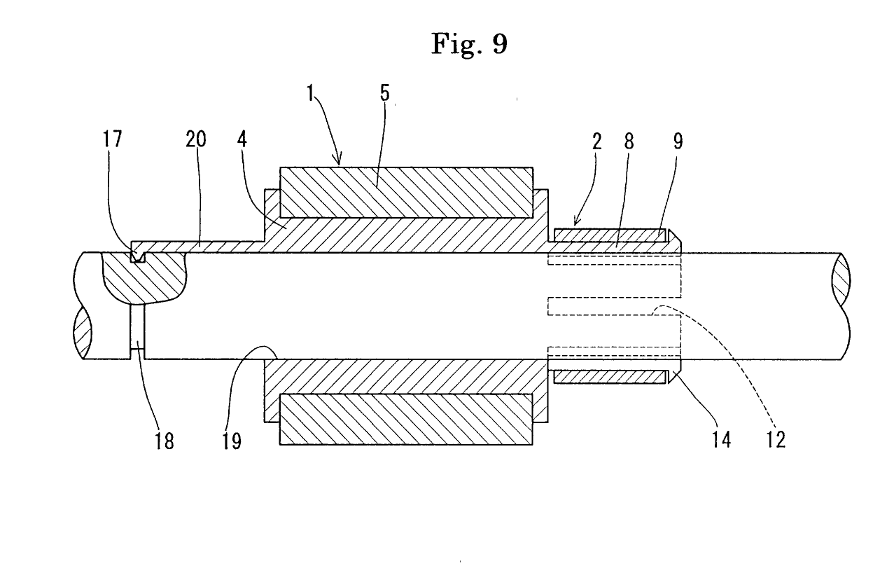

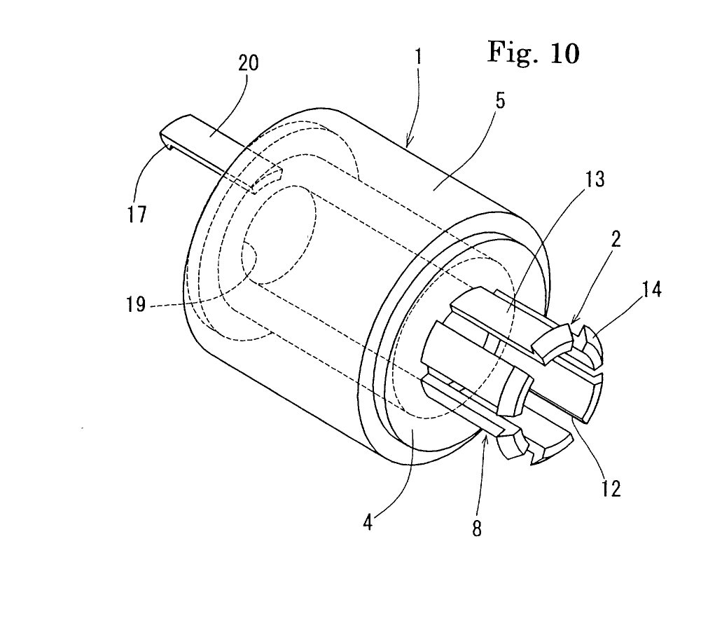

In the fourth embodiment shown in FIGS. 9 and 10, on the side opposite to the sleeve 8 of the roller body 4, an arm 20 is formed so as to protrude in the axial direction along the shaft 3. A positioning claw 17 is provided at its tip so as to be engaged in an annular groove 18 formed in the shaft 3. Otherwise it is the same as with the third embodiment.

The rotary member with the torque limiter of each of the embodiments meets the requirements for compactness and unitization, but still has the following problem. That is, since the roller body 4 and the split sleeve 8 are formed of a resin in a mold, it is necessary to provide the mold with portions for forming the required number of slits 12 in its portion for forming the sleeve 8. Since the portions where the slits 12 are formed are thin portions sandwiched by cavities on both sides, trouble such as chipping may occur during forming, thus shortening the life of the mold.

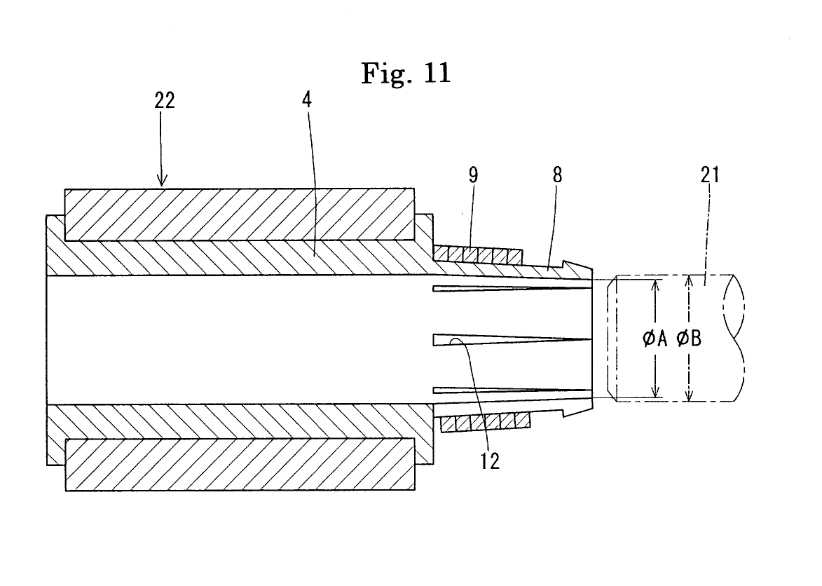

This problem can be solved by setting the width of the slits 12 large. But if the width of the slits 12 is increased, as shown in FIG. 11, when the elastic member 9 (coil spring) is mounted on the sleeve 8, due to its binding force, the sleeve 8 will shrink at its tip (see inner diameter φA) so as to be smaller than the outer diameter φB of the shaft 21. Thus, it becomes difficult to insert the shaft 21 from the side of the sleeve 8.

Also, if an elastic member 9 having a large spring force is used to produce a large torque, it is difficult to expand the elastic member 9 to insert the shaft 21.

Also, if the rotary member 22 is a rubber roller, since it is long in the axial direction, the hole through which the shaft 21 passes is also long. Thus, it is necessary to keep the tolerance of the hole diameter over the entire length of the hole. Thus forming in a mold is difficult, and for preparation and modification of the mold, it takes much time and cost.

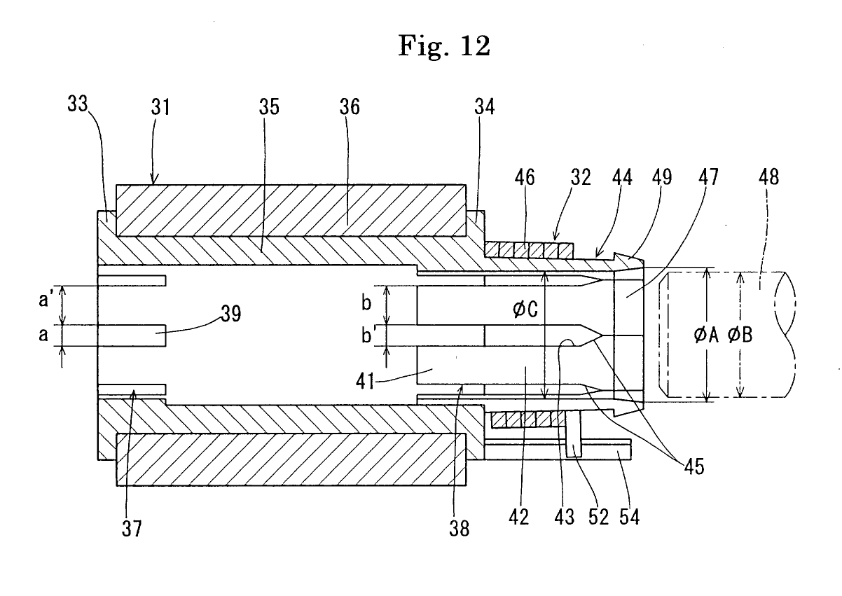

The fifth embodiment has solved this problem. The fifth embodiment shown in FIGS. 12-14 is a rubber roller with a torque limiter in which the torque limiter 32 is integrally provided at one end of the rubber roller 31. The rubber roller 31 has a rubber sleeve 36 covering the outer peripheral surface of a sleeve-like roller body 35 having flanges 33, 34 at both ends. Also, radial bearings 37 and 38 are provided on the inner surface of the roller body 35 at both ends thereof.

As shown in FIG. 12, the one radial bearing 37 has its bearing ribs 39 having a width a0 arranged at a constant pitch with intervals a′. The other radial bearing 38 has its bearing ribs 41 having a width b arranged at a constant pitch with intervals b′. In this embodiment, they are set to meet relations a<b and a′>b′.

The intervals a′ are of such a size that the bearing ribs 41 having the width b fit without any gap. The intervals b′ are of such a size that the bearing ribs 39 having the width a fit without any gap. By setting the circumferential positional relation of the bearing ribs 39 and 41 in such a relation that the phase is displaced by one pitch in the circumferential direction, it is possible to avoid being undercut, so that it is possible to form the inner peripheral surface of the roller body 35 in a mold.

The bearing ribs 41 forming the radial bearing 38 extend in the axial direction while keeping the width b and intervals b′, thus forming split sleeve pieces 42 and slits 43. A split sleeve 44 is formed by the sleeve pieces 42 and the slits 43. The width of each sleeve piece 42 increases at the inclined step portions 45 on both sides. As will be described later, when a coil spring 46 is mounted on the outer surface of the split sleeve 42, both sides of the adjacent sleeve pieces 42 abut each other to form an annular portion 47 as a whole.

The inner peripheral surface of the annular portion 47 is tapered so as to outwardly increase in diameter and serves as a guide when a shaft 48 is inserted. Ribs 49 for preventing the coil spring 46 from coming out are provided on the outer peripheral surface of the annular portion 47. The outer surfaces of the ribs 49 are also tapered to serve as a guide when the coil spring 46 is mounted.

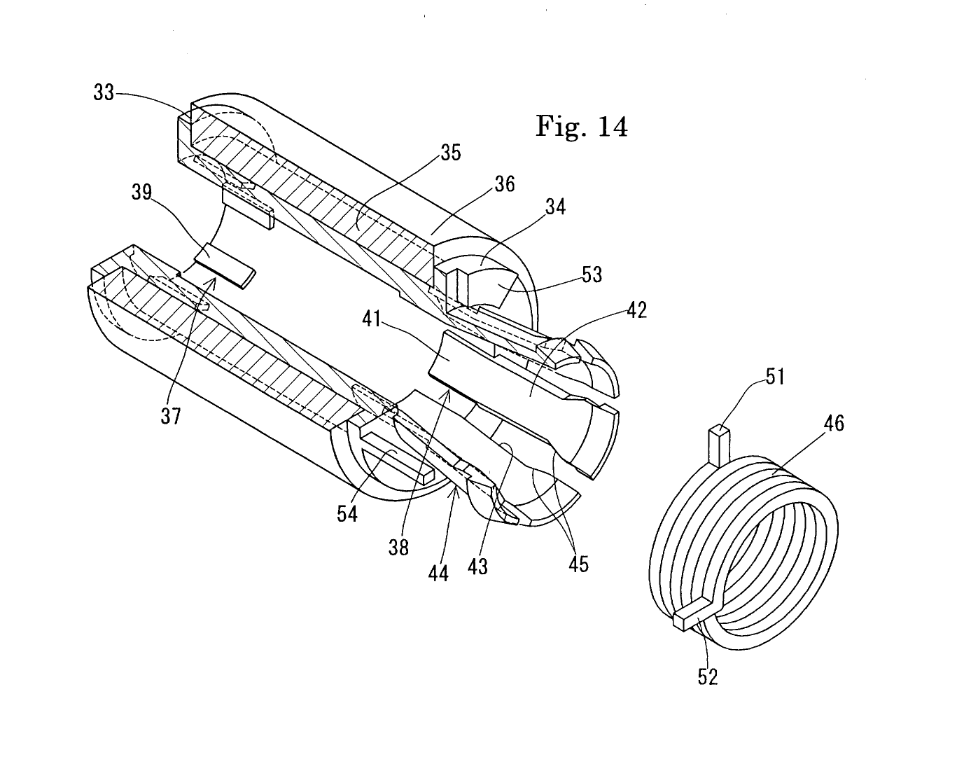

The shape of the split sleeve 44 when formed is, as shown in FIG. 14, such that the sleeve pieces 42 open outwardly so that the tips are spread open. As a result, the slits 43 also open with the tips separated from one another. Thus, the portions of the mold for forming the slits 43 are also large in thickness. This avoids the fear of chipping of the mold.

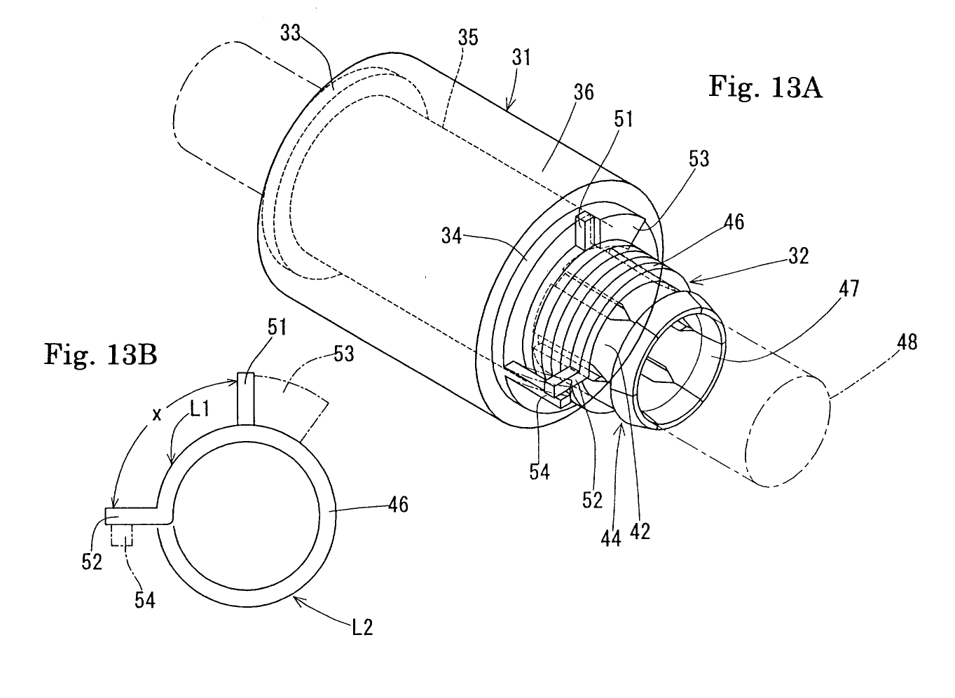

The coil spring 46 is formed by winding a square spring wire (though a round spring wire can also be used.) with hooks 51, 52 at both ends thereof bent outwardly in the diametric direction. The fraction x of winding (see FIG. 13B) is suitably set in the range of over zero and less than a half turn. In this embodiment, it is set at a quarter turn. By providing such a fraction x, a minor arc L1 (=fraction x) and a major arc L2 are formed between the hooks 51, 52. If force is applied in such a direction that the minor arc L1 decreases so that the hooks 51 and 52 approach each other, the diameter of the coil spring 46 will increase elastically.

The coil spring 46 is mounted on the split sleeve 44 to shrink it and thereby to bring the tips of the respective sleeve pieces 42 into abutment with each other in the circumferential direction to form the annular portion 47. The hook 51, which is on the side of the flange 34 of the coil spring 46, is in engagement with a sector-shaped protrusion 53 provided on the outer end face of the flange 34 (FIG. 13A). The other hook 52 is similarly in engagement with a pin-shaped protrusion 54 protruding from the outer end face of the flange 34.

In the state of FIGS. 12 and 13, in which the coil spring 46 is mounted around the split sleeve 44 to shrink the split sleeve 44 with its binding force, the relations of the inner diameter φA of the annular portion 47 at its tip, the outer diameter φB of the shaft 48, and the inner diameter φC of the split sleeve 44 are in the relation φB<φA>φC. Thus it is easy to insert the tip of the shaft 48 into the annular portion 47. Also, the difference between φB and φC is the interference relative to the shaft 48. The shaft 48 is inserted while expanding the annular portion 47 by an amount equal to the interference. If insertion is difficult, the diameter of the split sleeve 44 is increased by applying an external force so that both hooks 51 and 52 of the coil spring 46 will approach toward the minor arc L1 to weaken the binding force of the coil spring 46.

In this case, although external force may be directly applied to the hooks 51, 52, by imparting flexibility to the pin-shaped protrusion 54, by pushing it toward the other hook 51 with a fingertip, it is possible to move the hook 52 toward the hook 51 and expand the coil spring 46.

The thus inserted shaft 48 is rotatably supported on the radial bearings 37 and 38 at two locations on the inner surface of the roller body 35.

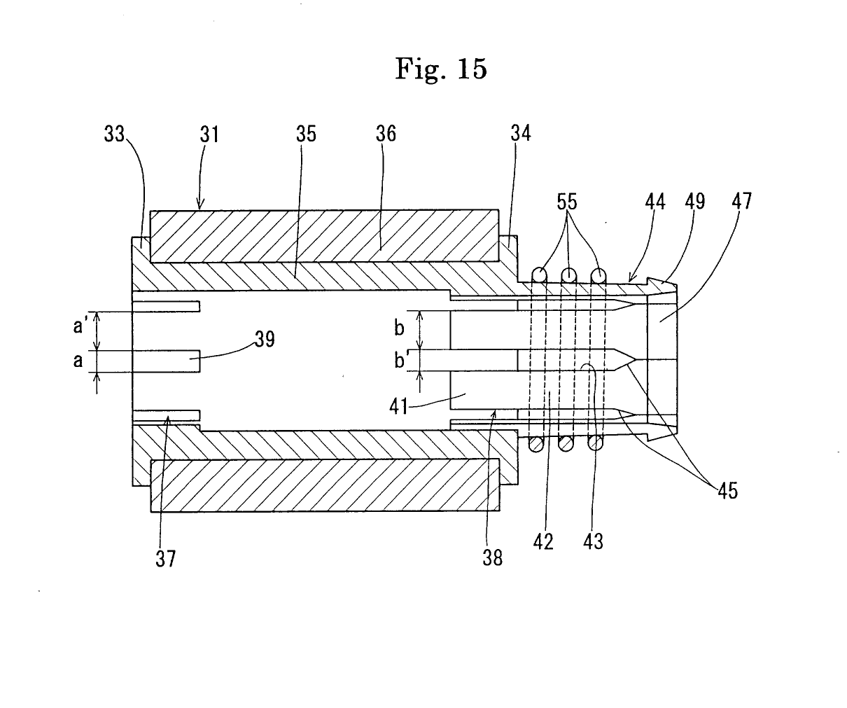

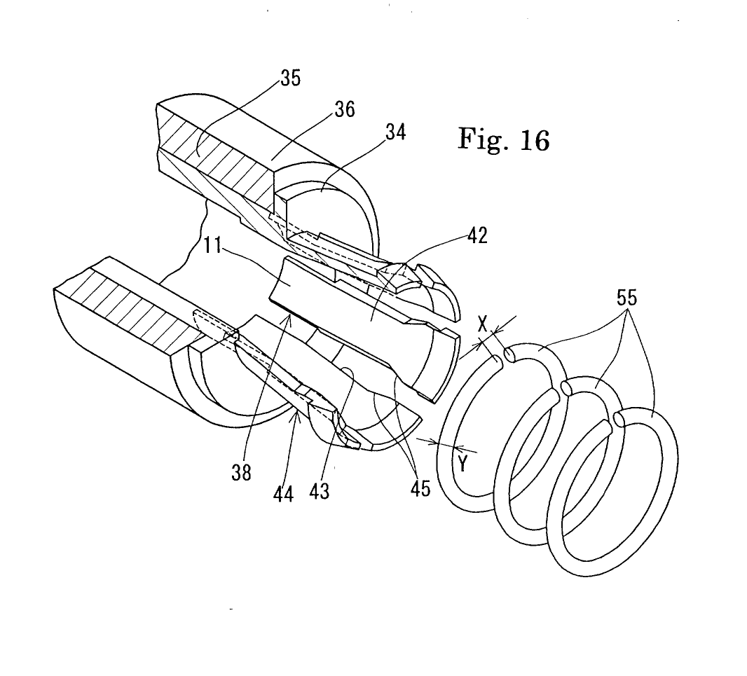

In this fifth embodiment, as a binding means for the split sleeve 44, the coil spring 46 is used. But instead of the coil spring 46, as shown in the modification of FIGS. 15 and 16, a required number of C-shaped rings 55 may be used. By suitably changing the number thereof, it is possible to finely adjust the binding force in a stepwise manner. Also, as shown in FIG. 16, by setting the cut-out width x of the C-shaped rings 55 smaller than their wire diameter Y, the C-shaped rings are less likely to tangle each other. In this case, except that the protrusions 53 and 54 are not necessary, other structures are the same as with the above embodiment.

With the rubber roller with a torque limiter of the fifth embodiment, the torque between the shaft 48 and the rubber roller 31 is determined by the binding force of the coil spring 46 or C-shaped rings 55 which shrinks the split sleeve 44. If the load applied to the rubber roller 31 exceeds the torque value, idling occurs, so that transmission of the torque is shut off.

Although the fifth embodiment is applied to a rubber roller, this invention can be applied to other rotary members than the rubber roller.

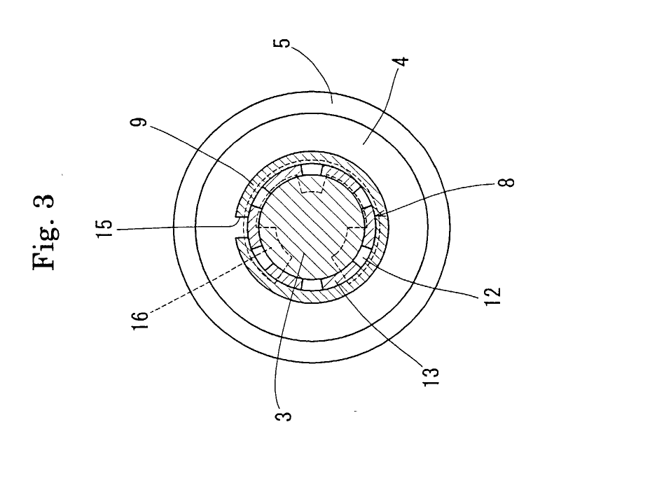

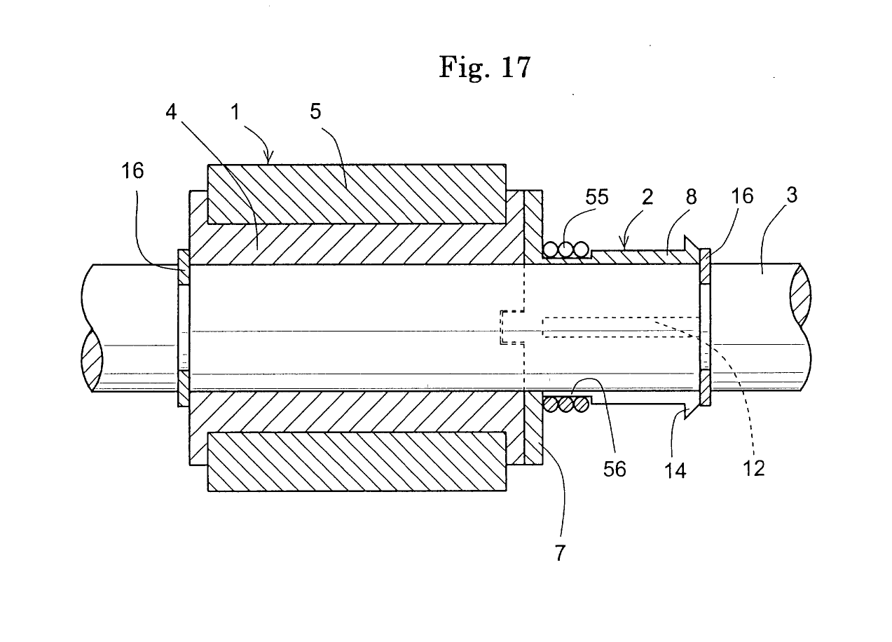

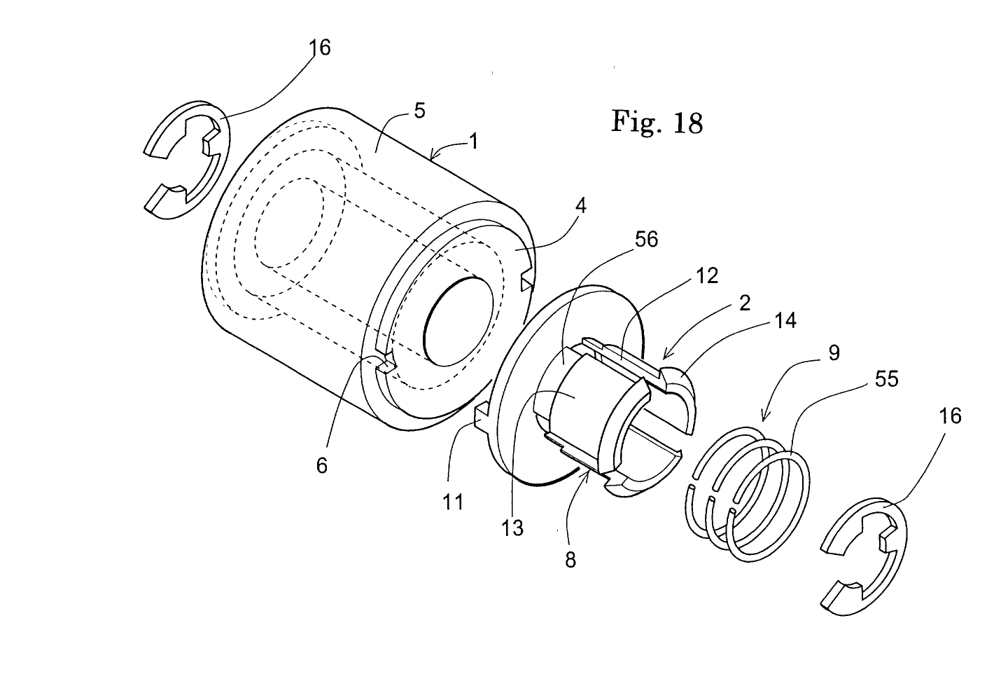

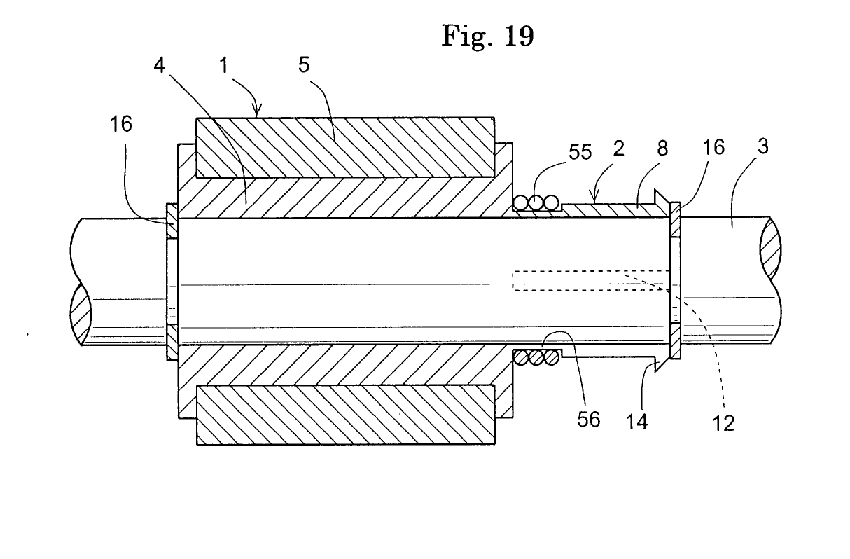

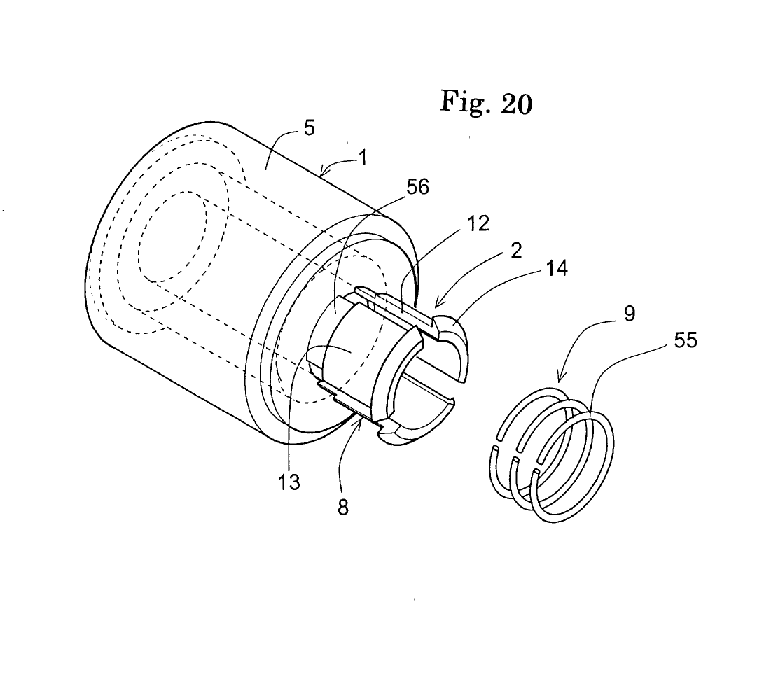

Next, the sixth embodiment shown in FIGS. 17 and 18 is common in its basic structure with the first embodiment (FIGS. 1-4) and the seventh embodiment shown in FIGS. 19 and 20 is common with the second embodiment (FIGS. 5 and 6), so that to the same portions, only the same numerals are attached and description will be mainly made only about different structures.

In the sixth and seventh embodiments, they are common in that the split sleeves 8 are split into three, that three C-shaped rings 55 are used as the elastic members 9, and that a circumferential recess 56 is formed in the root of the split sleeves 8 (boss portion 7 in the sixth embodiment, end on the side of the roller body 4 in the seventh embodiment), and that the C-shaped rings 55 are fitted in the recess 56 with a predetermined binding force. The reason why the split sleeve 8 is split into three, the one why the C-shaped rings 55 are fitted at the root of the split sleeve 8, and the one why the recess 56 is formed in the fitting portion will be described below.

(1) Reason why the split sleeve 8 is split into three:

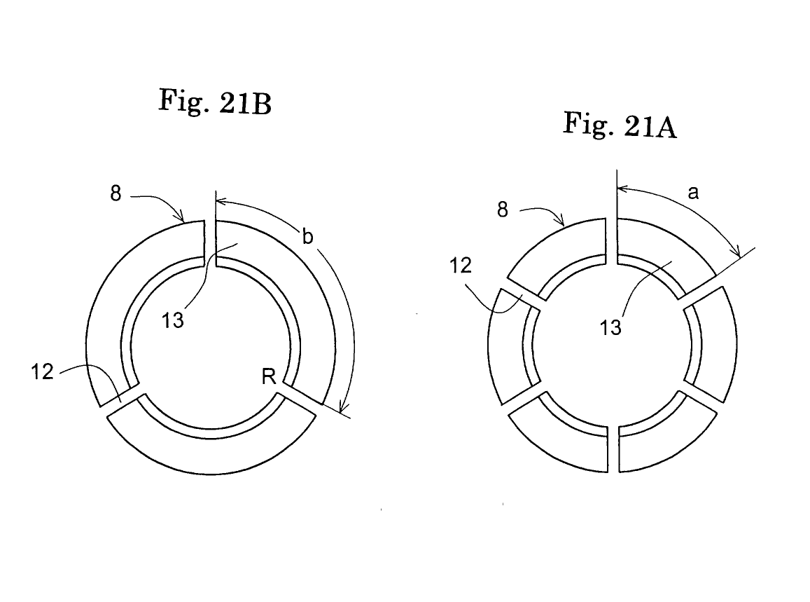

In the first to fifth embodiments, the split sleeve 8 is split into six. For the cases in which it is applied to the shaft having the same diameter, splitting into six and splitting into three were compared and shown in FIGS. 21A and 21B. If the slits 12 are uniform, the relation between the widths (i.e. circumferential lengths) a and b of the sleeve pieces is naturally a<b.

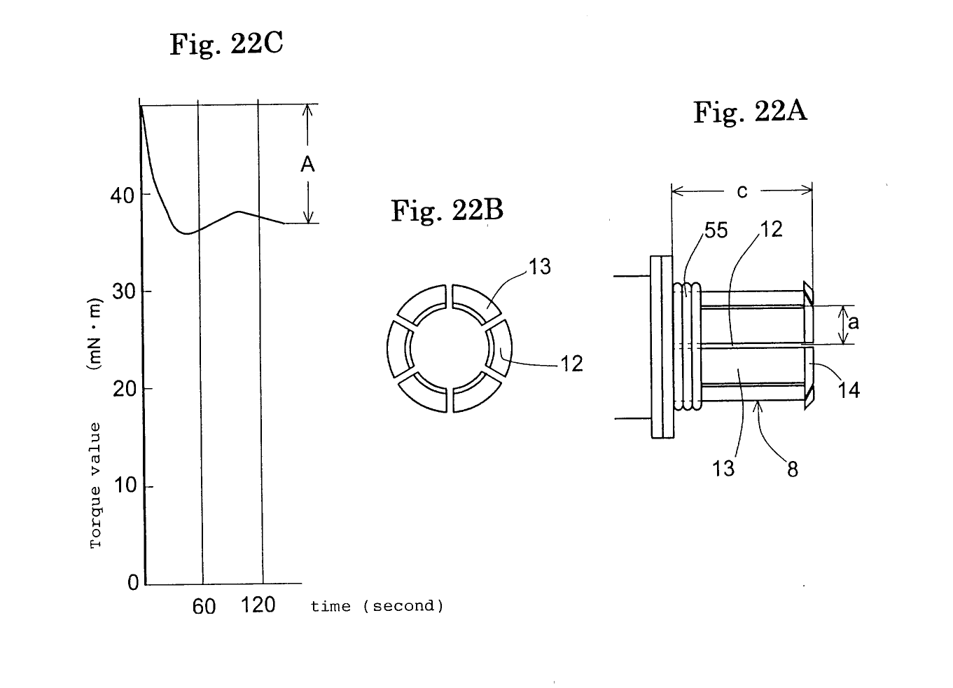

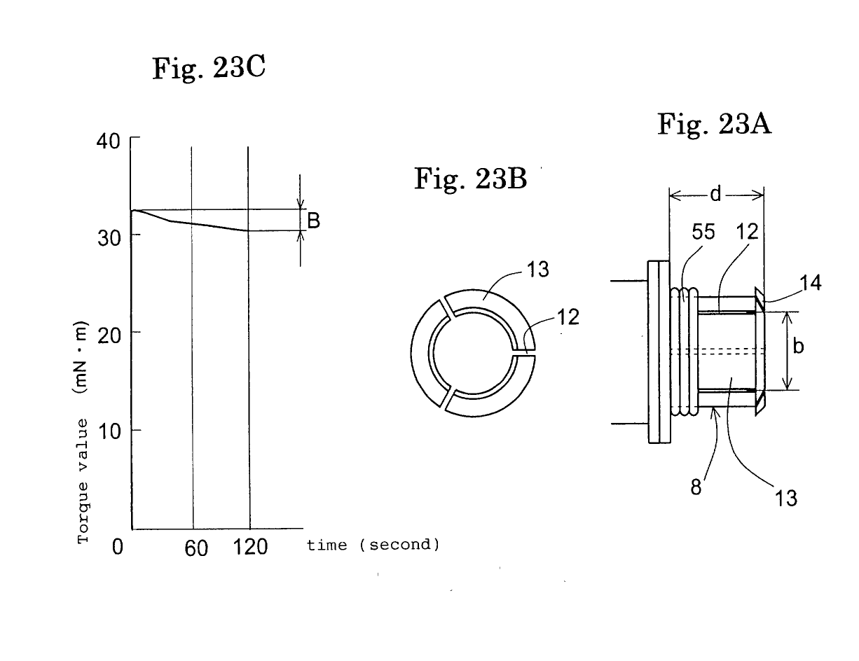

The magnitude of torque variation due to the difference in the circumferential lengths of the split sleeves was examined. The results are shown in FIG. 22 (splitting into six) and FIG. 23 (splitting into three).

In FIGS. 22A and 22B in which the circumferential length of the split sleeve pieces are relatively short, since the circumferential rigidity is low, when the torque limiter rotates relative to the shaft, thereby producing torque, circumferential deflection due to shaft rotation is produced in the split sleeve 8. This causes change in the attitude of the split sleeve 8 relative to the shaft before and after the relative rotation, thus changing the binding force and thus the frictional force between the shaft and the split sleeve 8, so that the produced torque changes significantly (see torque fluctuation A in FIG. 22C). In this case, the circumferential length a of each sleeve piece 13 is 2.5 mm, and its axial length c is 8.5 mm and a/c is 0.29.

In contrast, in FIG. 23A and 23B in which the circumferential length of the sleeve pieces 13 is relatively long, since the circumferential rigidity is higher, the shape of the split sleeve 8 stabilizes relative to the shaft even for relative rotation and thus contact with the shaft stabilizes. Thus, torque fluctuation is small (see torque fluctuation B in FIG. 23C). In this case, the circumferential length b of each sleeve piece 13 is 5.2 mm and its axial length d is 5.7 mm and b/d is 0.912. It is considered that if this ratio is in the range of 0.9±0.1, similar effects are achieved.

As for the shape of each sleeve piece 13 of the split sleeve 8, by setting the ratio of its circumferential length to its axial length at 0.9±0.1, a sufficient circumferential length is ensured relative to the axial length of the sleeve pieces 13, rigidity in the rotational direction is assured.

(2) Reason why the C-shaped rings are fitted at the root of the split sleeve:

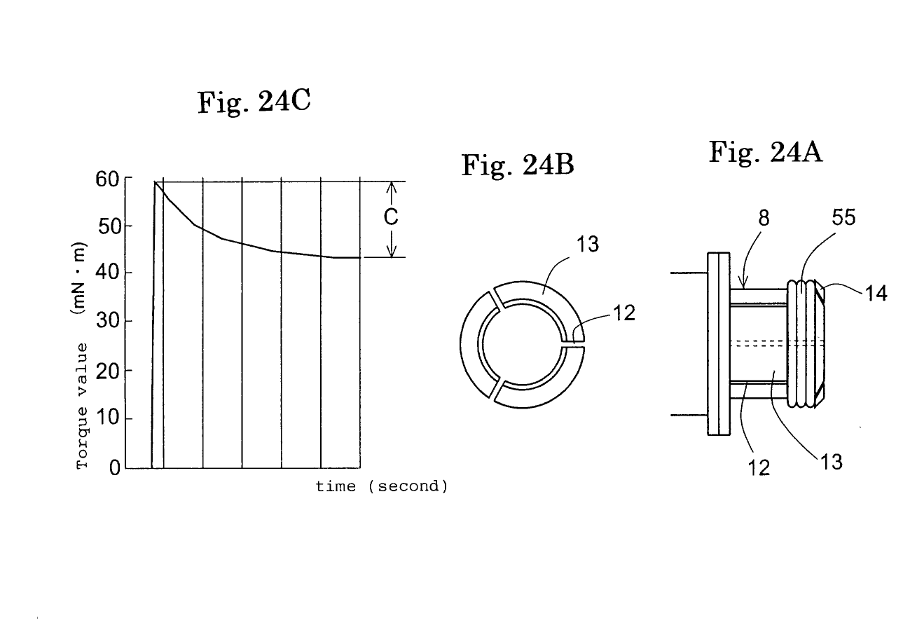

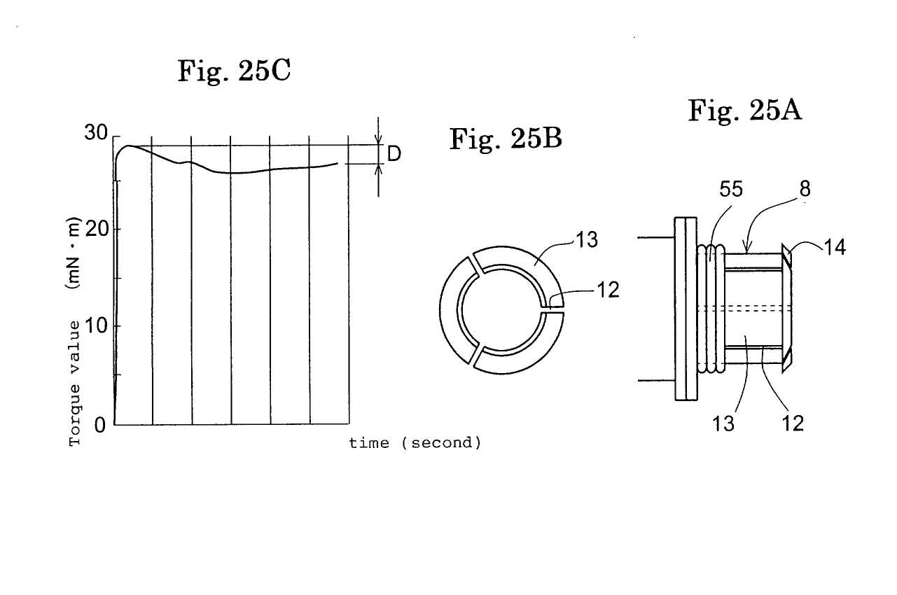

If springs such as the C-shaped rings were fitted at a position remote from the root of the split sleeve 8 (see FIGS. 24A and 24B), when the torque limiter rotates relative to the shaft, besides the binding force on the shaft, a moment load tends to be applied to the split sleeve 8, thus producing deflection in the split sleeve 8. Thus, the attitude of the split sleeve 8 relative to the shaft will change after relative rotation, thus changing the binding force and thus the frictional force between the shaft and the split sleeve 8. This causes a relatively large change C in the generated torque (FIG. 24C). In contrast, if the C-shaped springs 55 are fitted at the root of the split sleeve 8 (FIGS. 25A and 25B), it is possible to suppress generation of moment force in the split sleeve 8, so that the change D in the generated torque (FIG. 25C) relatively decreases.

(3) Reason why the portion where the C-shaped springs are fitted is formed with a recess:

By providing a recess 56 in the root of the split sleeve, it is possible to position the C-shaped springs 55 and prevent them from coming out.

(4) Others

By increasing the circumferential length of each sleeve piece 13, it is possible to increase the circumferential rigidity and make it easy to mount the C-shaped springs 55 onto the split sleeve 8 by improving radial deflection of the sleeve pieces 13.

The torque limiter and the rotary member with a torque limiter of this invention reveal the following effects.

(1) Since torque is generated by fitting an elastic member on a sleeve having shrinking elasticity, the torque value is determined by setting the part dimension of the elastic member to a predetermined value. Thus, adjustment of the torque value after assembly is not necessary. Thus the rotary member with a torque limiter can be easily manufactured. Also, since no inner member or outer member as conventional is necessary, the outer diameter of the torque limiter can be decreased.

(2) By providing the sleeve or rotary member itself with the positioning portion, a positioning snap ring or pin as a separate part is not necessary. In this regard too, compactness is possible.

(3) If the torque value needs to be increased, elastic members have only to be radially superposed. Thus, compact design is possible because it has no influence on the axial dimension.

(4) By forming the split sleeve in such a shape that its tip has an increased diameter, since the distances between the slits increase, a mold can be manufactured easily. Also, it is possible to prevent chipping of the mold and make its life longer.

(5) Even if a spring having a binding force is mounted on the split sleeve, since the annular portion at its tip restricts reduction in diameter, it is possible to easily insert the shaft.

(6) Since the radial bearings are provided on the inner surface of the rotary member body at its both ends, dimensional accuracy of the inner diameter is required to these portions only, so that manufacture is easy. Since the phase of the positions of the bearing protrusions on both sides is offset, undercut portions are eliminated, so that forming in a mold is possible.

(7) If a coil spring is used as a binding means for the split sleeve, by setting the number of windings at half winding or less, preferably at about 20 to 45 degrees, it is easy to move the hooks at both ends in such directions as to approach each other relative to each other to increase the diameter of the coil spring. In particular, by giving flexibility to a pin-like protrusion engaging one hook, it is possible to increase the diameter of the coil spring simply by pushing the protrusion toward the other hook.

(8) If the C-shaped rings are used as the means for binding the split sleeve, their diameter can be easily increased compared with the coil spring and the shaft can be more easily inserted. Also, in the case of the coil spring, it is necessary to adapt the mounting positions of the hooks at its both ends to the engaging groove, so that mounting work is inconvenient. Further, since the C-shaped rings need no elements corresponding to the hooks of a coil spring, they are compact.

(9) By relatively increasing the circumferential length of the sleeve pieces, it is possible to increase its rigidity. Thus, even when the split sleeve rotates relative to the shaft, it is possible to stabilize the shape. This makes it possible to produce a stable torque.

(10) By fitting the elastic member such as C-shaped ring at the root of the split sleeve, it is possible to suppress generation of moment force in the split sleeve. Thus the contact between the shaft and the split sleeve stabilizes. This stabilizes generated torque.

(11) By forming the recess for receiving the elastic member such as the C-shaped rings in the outer surface of the split sleeve, it is possible to position the elastic member and prevent it from coming out.

What is claimed is:

1. A torque limiter comprising a sleeve having an annular boss portion and mounted on a shaft, and a ring-like elastic member, said sleeve being imparted elasticity in the diameter-reducing direction, said elastic member being mounted on said sleeve to shrink said sleeve, whereby generating a radial force relative to said shaft.

2. A torque limiter as claimed in claim 1 wherein said sleeve is formed with axial slits open at tip thereof at predetermined intervals in the circumferential direction to impart elasticity in the diameter-reducing direction to said sleeve.

3. A torque limiter as claimed in claim 1 or 2 wherein said elastic member comprises a tubular spring formed with an axial slit extending over its entire length.

4. A torque limiter as claimed in claim 1 or 2 wherein said elastic member comprises a plurality of tubular springs superposed one upon another and each formed with an axial slit extending over its entire length.

5. A torque limiter as claimed in claim 1 or 2 wherein said elastic member is a coil spring.

6. A torque limiter as claimed in claim 1 or 2 wherein said elastic member is an elastic C-shaped ring.

7. A rotary member with a torque limiter comprising a rotary member rotatably mounted on a shaft and a torque limiter portion which is separate from said rotary member, said rotary member and said torque limiter portion being integrally joined together so as to rotate together on said shaft, said torque limiter portion being the torque limiter claimed in any of claims 1-6.

8. A rotary member with a torque limiter comprising a rotary member rotatably mounted on a shaft and a torque limiter integral with said rotary member, said torque limiter portion being the torque limiter claimed in any of claims 1-6.

9. A rotary member with a torque limiter as claimed in claim 7 or 8 wherein one of said rotary member and said torque limiter portion is provided with a positioning portion for positioning relative to said shaft.

10. A rotary member with a torque limiter, comprising a rotary member and a torque limiter provided at one end of said rotary member, said torque limiter comprising a split sleeve formed with a plurality of axial slits and a spring mounted on said split sleeve to generate a torque between said split sleeve and said shaft, wherein said split sleeve is formed to spread at one end thereof and has its diameter reduced to a required diameter by the binding force of said spring.

11. A rotary member with a torque limiter as claimed in claim 10 wherein said split sleeve has a plurality of sleeve pieces and the width of the tips of said sleeve pieces is set such that they abut each other to form an annular portion when said split sleeve is shrinked by the binding force of said spring, and wherein the width of portion of said sleeve pieces other than the tips thereof is smaller than the width of the tips.

12. A rotary member with a torque limiter as claimed in claim 10 or 11 wherein radial bearings are formed on the inner surface of said rotary member at both ends thereof, said radial bearings each comprising a plurality of bearing ribs arranged in a circumferential direction, said phases of the positions of said bearing ribs are displaced from each other.

13. A rotary member with a torque limiter as claimed in any of claims 10-12 wherein said spring is a coil spring, wherein the fraction of the number of windings of said spring is set to less than a half turn, and wherein hooks are provided at both ends thereof and bent diametrically outwardly.

14. A rotary member with a torque limiter as claimed in claim 13 wherein engaging portions for engagement with said hooks are formed on the end face of said rotary member on the side facing said torque limiter and circumferential flexibility is imparted to one of said engaging portions.

15. A rotary member with a torque limiter as claimed in any of claims 10-14 wherein said spring is a C-shaped spring having springness.

16. A rotary member with a torque limiter, comprising a rotary member and a torque limiter provided at one end of said rotary member, said torque limiter comprising a split sleeve formed with a plurality of axial slits and a spring mounted on said split sleeve to generate a torque between said split sleeve and said shaft, wherein said split sleeve is split into at least two sleeve pieces, and the ratio of the circumferential length of said each sleeve piece to its axial length is 0.9±0.1.

17. A rotary member with a torque limiter as claimed in claim 16 wherein said spring is mounted on said split sleeve at a position adjacent to said rotary member.

18. A rotary member with a torque limiter as claimed in claim 17 wherein an annular recess is formed in said split sleeve at a position where said spring is mounted.

19. A rotary member with a torque limiter as claimed in any of claims 16-18 wherein the axial length of said split sleeve is equal to or larger than the diameter of the shaft.
